(19) United States
(12) Patent Application Publication
(10) Pub. No.: US 2014/0046764 A1
(43) Pub. Date: Feb. 13, 2014

(54) COUPON SEARCH ENGINE

(71) Applicant: Sheryl M. Fox, Farmington Hills, MI (US)

(72) Inventor: Sheryl M. Fox, Farmington Hills, MI (US)

(21) Appl. No.: 13/961,432

(22) Filed: Aug. 7, 2013

Related U.S. Application Data
(60) Provisional application No. 61/680,384, filed on Aug. 7, 2012.

(51) Int. Cl. G06Q 30/02

(52) U.S. Cl. CPC G06Q 30/0257
USPC 705/14.55

(57) ABSTRACT

A mobile coupon application including a coupon search engine in electronic communication with a shopping list function and a scanning function, the mobile coupon application stored on a computer-readable medium on a mobile device. A method of generating coupons by entering search parameters on a coupon search engine, searching for coupons for an item with the coupon search engine, and presenting resulting coupons for the item on a screen of a mobile device. A method of generating coupons by scanning barcodes of items, creating a shopping list of items from the scanned barcodes, searching for coupons for the items based on the scanned barcodes with the coupon search engine, and presenting resulting coupons for the items on a screen of a mobile device.

### BACKGROUND OF THE INVENTION

1. Technical Field

The present invention relates to applications and processes for managing and collecting coupons. More specifically, the present invention relates to automatic and manual coupon generation and organization.

2. Background Art

There are many people who use coupons and there are many sources for coupons. Coupons can be found in the mail, in the newspaper, online, or in stores aisles or circulars. The sources of coupons are often overwhelming and it can be very difficult to go through all of these sources in order to extract the coupons that are useful. It can also be very hard to keep track of coupons and organize them in a way in which it is easy to find them when needed. Many coupons expire because people forget to use them, do not have the coupons with them when they are shopping last-minute or on the go, or have just forgotten to bring the coupons with them when they are at the store. Furthermore, it can be a waste of paper to print coupons off of the Internet. Everyone receives, especially over the weekend, massive coupon mailings with their daily newspaper, most of which are discarded, resulting in a gross waste of paper resources.

Many smart phones, tablets and mp3/4 players such as iPODs® (Apple, Inc.) can operate applications related to coupons. For example, GROUPON™ (Groupon, Inc.) places daily coupons on the Internet that can be purchased and accessed (with a barcode that the store then scans) through an application directly. GROUPON™, however, only provides coupons for those merchants with which they have partnerships and one must purchase that coupon (it is not free), and the merchant and GROUPON share in the proceeds from the coupon purchase.

There are, of course, other coupon organizing applications and mobile coupon applications. For example, YOWZA!!® (Yowza International, Inc.) is a mobile coupon application that uses a person's current location based on the GPS in their mobile device (iPHONE® (Apple, Inc.)) to find coupons close to that location, favorite stores can be saved, the coupons and their barcodes are stored right on the mobile device, and your savings can be tracked. While these coupon applications are very useful, they do not fully use all sources of coupons and do not provide other functions to the user that are needed when shopping with coupons, and only access a very narrow sample of stores.

Therefore, there remains a need for a coupon organizing and searching application that uses many sources of coupons and provides greater functionality to users.

### SUMMARY OF THE INVENTION

The present invention provides for a mobile coupon application including a coupon search engine in electronic communication with a shopping list function and a scanning function, the mobile coupon application stored on a computer-readable medium on a mobile device.

The present invention also provides for a method of generating coupons by entering search parameters on a coupon search engine, searching for coupons for an item with the coupon search engine, and presenting resulting coupons for the item on a screen of a mobile device.

The present invention further provides for a method of generating coupons by scanning barcodes of items, creating a shopping list of items from the scanned barcodes, searching for coupons for the items based on the scanned barcodes with the coupon search engine, and presenting resulting coupons for the items on a screen of a mobile device.

The present invention further provides for a method of storing a list, the user's chosen specific items and brands of each item in the list, and searching for coupons for those items in the list if selected so that a shopping list is automatically generated as well as any coupons corresponding to each item in the shopping list and learn patterns to intelligently prompt coupons and prices.

The present invention further provides for a method of generating feedback to a merchant as a marketing tool when a consumer accepts its competitively pushed coupon to purchase the competitor merchant's product in lieu of the consumer's originally intended purchase.

### DESCRIPTION OF THE DRAWINGS

Other advantages of the present invention are readily appreciated as the same becomes better understood by reference to the following detailed description when considered in connection with the accompanying drawings wherein:

FIG. 1 is a flow chart showing the flow of information in the mobile coupon application;

FIG. 2 is a flow chart showing the flow of information in the coupon search function;

FIG. 3 is a flow chart showing the flow of information in the shopping list function for generating coupons for a particular meal; and

FIG. 4 is a flow chart of information between users, stores, manufacturers and the mobile coupon application.

### DETAILED DESCRIPTION OF THE INVENTION

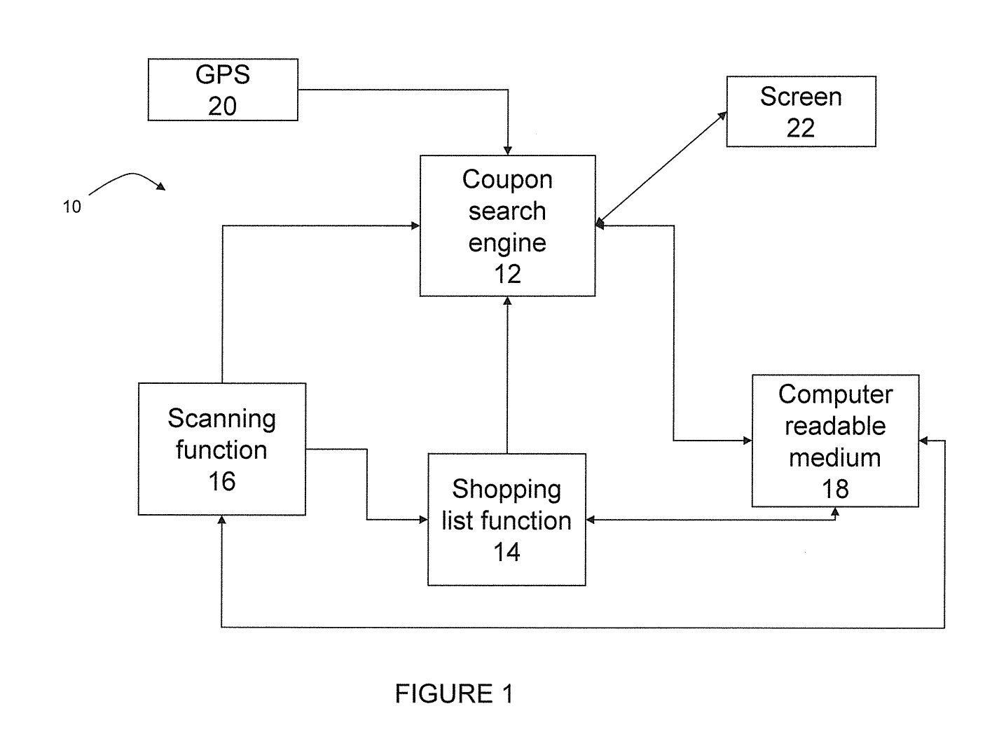

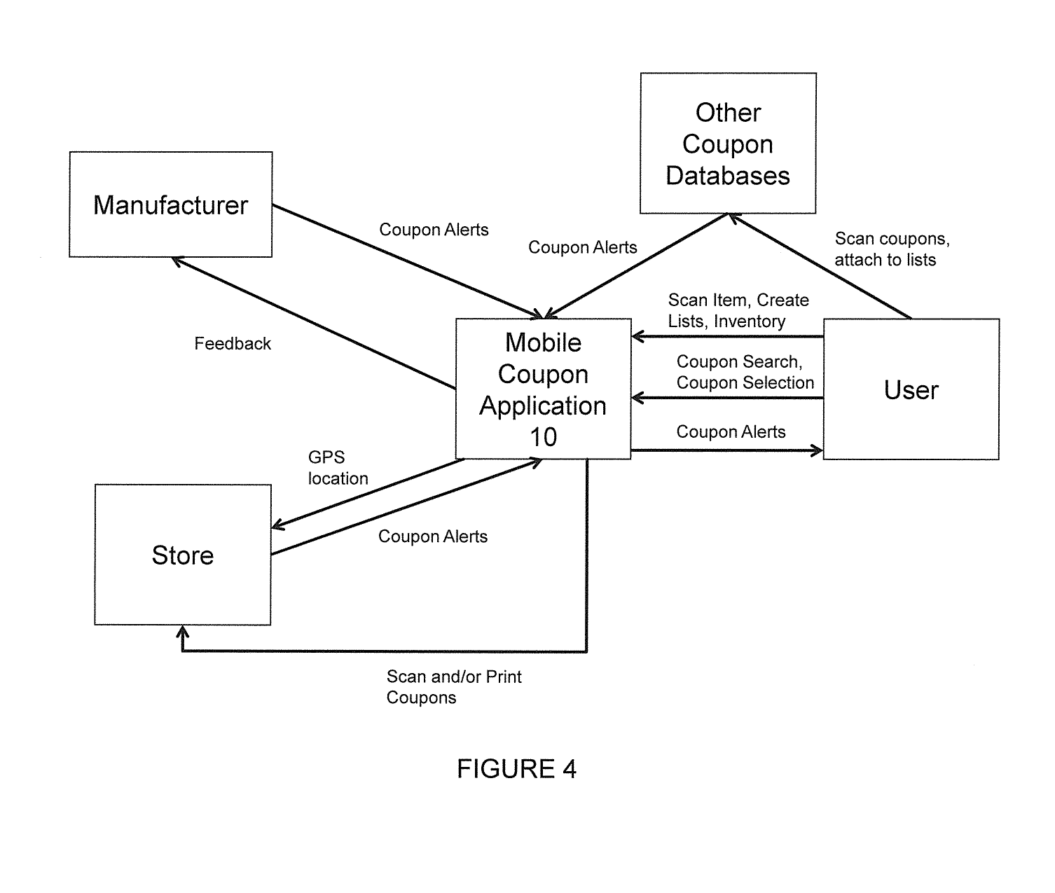

The present invention is generally directed to a mobile coupon application, shown generally at 10 in FIG. 1, for a mobile device that includes a coupon search engine 12, a shopping list function 14, and a scanning function 16, all in electronic communication. The mobile coupon application is stored on a computer-readable medium 18 within the mobile device. FIG. 4 shows the relationship between the user, a store, and a manufacturer with the mobile coupon application 10, and each of the functions are further described below.

The term “application” as used herein refers to a computer software application, otherwise known as an “app”, that is run and operated on a mobile device, such as, but not limited to, smart phones (IPHONE® (Apple, Inc.), ANDROID™ devices (Google, Inc.), WINDOWS® devices (Microsoft)), mp3 players (IPOD TOUCH® (Apple, Inc.)), or tablet computers (IPAD® (Apple, Inc.)), especially ones utilizing a touch screen.

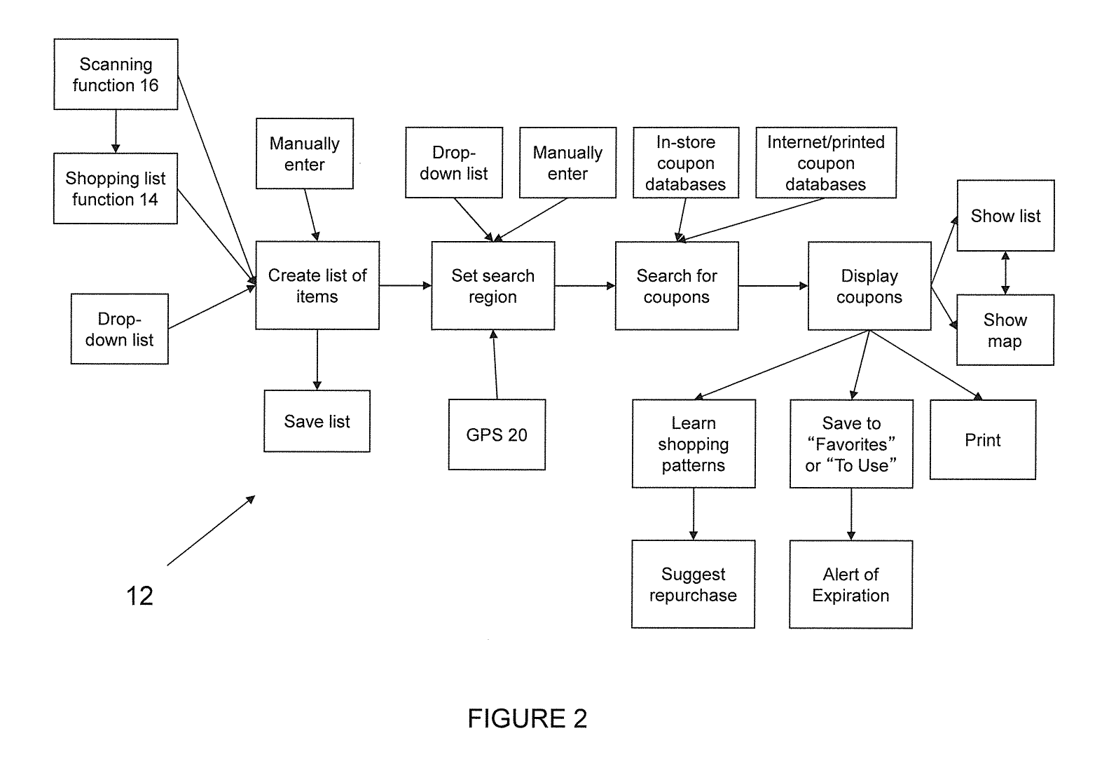

A flow chart showing different steps that can be taken in the coupon search engine 12 is generally shown in FIG. 2.

Various search parameters can be entered in the coupon search engine 12 in order to search for coupons. One of the most important parameters is the search region. The coupon search engine 12 can search all available coupon databases within a particular region in order to generate coupons, such as, but not limited to, a ZIP code, a city, a state, or a geographic region within miles (5, 10, 20, 50 miles, etc.) of a location. The search region is definable by the user through a region-defining function that can be chosen from a drop-down menu or manually entered. That is, the region can be expanded or contracted, depending on the needs of the user. It can be specifically defined by ZIP code, mile range, by store type or name, etc. Alternatively, an ongoing search function can be used that utilizes GPS functionality to inform the user of nearby stores and/or service providers whose coupons are available and can be of use to the user.

The coupon search engine 12 is preferably in electronic communication with a GPS 20 in the mobile device and can thus automatically obtain location information of the user. The coupon search engine 12 can actively search coupon databases as the user's location changes and present coupons close to their present location with an alert. For example, when driving near a drug store, an alert can be activated and a coupon associated with the drug store can pop up on the screen 22 of the mobile device and an alert such as an alarm or noise can be sounded and/or a visual display can pop up. The alert can also be activated based on coupons that have been saved in a “To Use” list or a “Favorites” list (further described below). Communication with the GPS 20 can be turned on and off when desired by toggling the GPS function within the mobile coupon application 10, or by toggling the GPS function on the mobile device. Alternatively, location information for the coupon search engine 12 can be manually entered into the application. For example, if the user has listed a certain coupon or goods or services desired and the person is in a certain predefined proximity to the source of those goods and services and a coupon is available, the application will prompt the user. Such an application can also be used to prompt the user, if desired, even if a coupon is not available. Local comparative pricing can also be searched and displayed to provide the user with comparative shopping information to better make a purchase selection based on useful information.

Other parameters can also be set on the coupon search engine 12 such as, but not limited to, particular items, particular stores, online sites, types of coupons, or types of discounts available. These parameters can be chosen from standard items that can be selected from a drop-down list, the user can enter them manually, or information can be communicated from the shopping list function 14 further described below. Each of these parameters can be saved for repeated searching and designated as favorites. The coupon search engine 12 can also suggest competitor or generic items that are less expensive than a particular item that has been searched and a coupon selected. The coupon search engine 12 can also include a parameter for a target price that the user would buy an item at, and can alert the user when a coupon is available for that item that reduces the item to the target price. The coupon search engine 12 can further calculate which store in the area searched has the best “package pricing” for the items searched, and can include all of the items in a shopping list generated by the shopping list function 14.

The coupon databases can be generated from many different sources, such as, but not limited to, local stores, in-store coupons or rebates, vendor/merchant sites, promo code websites, search engines such as GOOGLE® (Google, Inc.) or BING® (Microsoft, Inc.), social media websites such as FACEBOOK® (Facebook, Inc.), coupon books such as ENTERTAINMENT® Book (Entertainment Publications), discount card memberships such as LAURA'S CARD™ (Laura's Card, Inc.), deal of the day websites such as GROUPON™ (Groupon, Inc.), LIVING SOCIAL™ (LivingSocial), and KosherKouponz™ (KosherKouponz), coupon mailers such as VALPAK® (ValPak Direct Marketing Systems, Inc.), newspapers, magazines, local neighborhood circulars, and combinations thereof. Therefore, this application uses many more sources of coupons than existing applications. And yet, although many more sources of information are made available, the net use of paper resources are absolutely minimized, making this application a totally green technology.

The coupon search engine 12 can present the results of the coupons in a list form or in a map form to show where the coupons are located. Both forms can also be used and the user can toggle between the list form and the map form. Clicking or touching a particular coupon on the list or map can provide more details about that coupon, such as amount of savings and terms and limitations. Coupons that the user is interested in can be saved to a “To Use” list or a “Favorites” list. The user can also create any other types of lists as desired.

Coupons can also be automatically entered in a “Favorites” list or the “To Use” list based on the user preferences for a particular store or particular item. These lists can be categorized according to user preferences such as by store or type of item. These lists and coupons can be stored on the computer-readable medium 18 of the mobile device, or they can be stored on a cloud and accessed through communication with the cloud over the Internet. The coupons that have been saved can also be in communication with a shopper's card account for a particular store, such as a CVS EXTRACARE® card or a Kroger® card. In this case, the shopper's card can be used at checkout and the coupons are transferred directly to the shopper's card.

The coupon search engine 12 can include an intelligent learning search function to learn specific shopping patterns over time and by location. It can suggest repurchases based on the availability of items and coupons based on learned patterns of purchases, thereby prompting the user when a likely need develops. For example, the application can learn that milk is purchased approximately every week at three alternative locations. The program can learn to prompt the user every week, informing the user of prices and coupon availability at the stores frequented by the user.

The intelligent learning search function can interact with the stored items in the “Favorites” list and suggest the overall least expensive location for purchasing the items for the entire “Favorites” list. The least expensive location can be suggested at a time that the intelligent learning search function suggests repurchasing the items. The least expensive location can also be suggested any time that coupons for the items become available. The intelligent learning search function can also suggest items that the user might be interested in that currently have coupons based on related items that the user previously searched for or are stored in the “Favorites” list.

The resulting coupons from a search can also include an alert that the coupons have special notices such as store-specific offers or promos such as for double or triple couponing. An alert can also be generated that coupons in the “To Use” or “Favorites” lists are expiring soon. This alert can be generated at a specified time that the user can adjust, such as a week, a couple days, or the day of expiry. The coupons generated in the search can also include information for where to print out the coupon if a user does not want to use their mobile device to access the coupon. For example, coupons can be printed out at a printer at the end of an aisle in a grocery store or at a cash register by electronically syncing the mobile coupon application 10 with the printer.

In order to use the coupons generated from the coupon search engine 12, the “To Use” list or “Favorites” list can be accessed and a particular coupon selected or the coupon can be selected directly from the results as above. The coupon and/or the barcode associated with the coupon are displayed on the screen 22 of the mobile device. The cashier at the store can then scan the barcode from the screen 22 or enter any information from the coupon manually. The user can then select or mark that the coupon has been used from the screen 22, and the coupon can be erased from the “To Use” list or “Favorites” list.

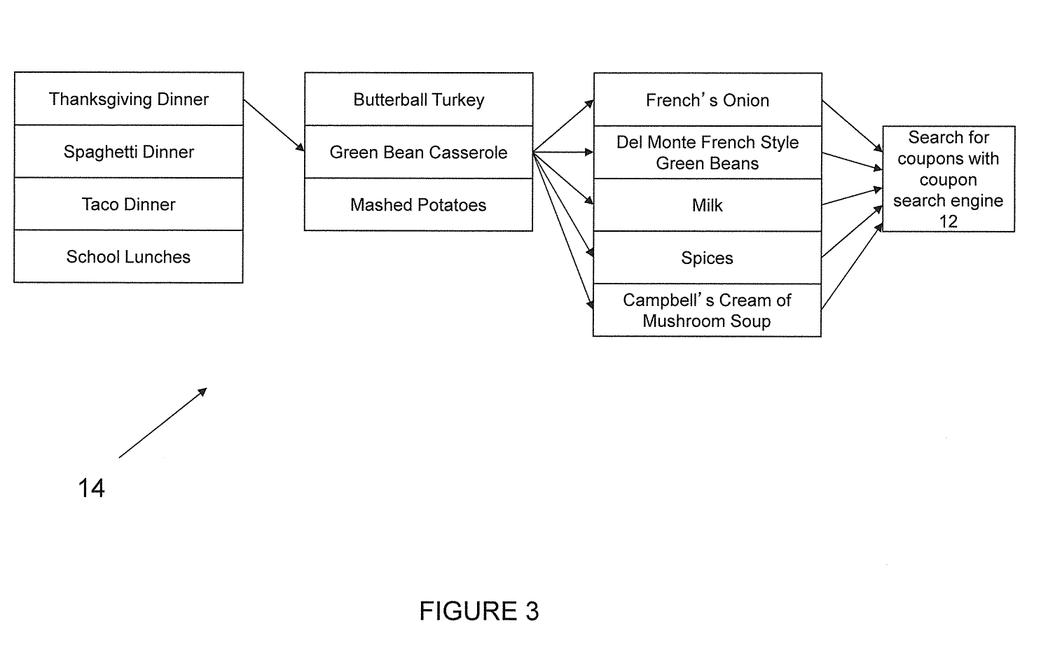

The shopping list function 14 can be used to create a shopping list and generate coupons for that list with the coupon search engine 12. A shopping list can be manually entered, the shopping list function 14 communicates the shopping list to the coupon search engine 12, and then coupons can be located based on the type of item on the shopping list. For example, bread can be entered on the shopping list, this information is sent to the coupon search engine 12, and then coupons for bread can be generated based on the parameters of the coupon search engine 12. Specific barcodes can also be manually entered for an item. The user can select a coupon or coupons they are interested in and save them to the “To Use” list. Shopping lists can also be created by the user for a specific meal, such as “Spaghetti Dinner”, which can contain spaghetti noodles, sauce, garlic bread, and parmesan cheese of brands that the user desires or just a general category of item and the coupon search engine can return coupons for any brand. FIG. 3 shows a flow chart of the steps that can be taken in the shopping list function 14 in choosing a shopping list for a Thanksgiving meal.

More preferably, the shopping list function 14 operates in conjunction with the scanning function 16. The scanning function 16 scans barcodes from packaging of items and can save the barcodes for the items to the shopping list function 14 in computer-readable medium 18 on the mobile device. The scanning function 16 requires a mobile device with a camera, as the camera is used to take a picture of the barcode of the item. By using the barcode of the item, a user can generate very specific coupons for the items that they require. This is a very useful feature for when an item has been used up because the user can quickly scan the barcode of the item to enter the item on the shopping list before throwing the packaging away. The user can also scan items remaining in the fridge or pantry that are nearly exhausted. Once the barcode of the item has been scanned and saved to the shopping list function 14, coupons can be generated as described above with the coupon search engine 12. The mobile coupon application 10 can also alternatively communicate electronically with a separate scanning application already on the mobile device.

Alternatively, the scanning function 16 can be used to scan the barcode on items and/or on shelves/displays in stores where the items are located directly in a store, communicate the information from the barcode of the item to the coupon search engine 12, and search for coupons. For example, as a user is walking down the aisle in a grocery store, the user can scan the barcode of an item or the barcode on the shelf and search for coupons for that item. The coupon search engine 12 can then retrieve a coupon for that item if available or suggest an alternative item that does have a coupon.

The scanning function 16 can also be used to generally inventory items in the pantry or fridge and alert the user to an item's expiration date approaching in order to keep fresh items in the home, or to save the item in a calendar for automatic prompting to replace. The expiration date can automatically be generated, or it can be manually entered by the user. For example, a carton of milk can be automatically set to expire two weeks from purchase, or the user can manually enter the expiration date if it differs. The scanning function 16 can also be used to indicate that an item in the inventory has been used. The user can enter in specific thresholds for minimums to automatically add the used items to the shopping list function 14 when the number of items in the inventory falls below that minimum.

The mobile coupon application 10 can further include a calculating function that keeps track of the total amount of savings obtained by using the coupons. This function can also alert the user to move the coupon savings into a bank savings account.

The mobile coupon application 10 can be used anywhere that coupons are accepted, such as, but not limited to, grocery stores, merchandise stores, hotels, services such as auto repair, hair/nail salons, amusement parks, and the Internet.

The present invention generally provides for a method of generating coupons by entering search parameters on the coupon search engine, searching for coupons for an item with the coupon search engine, and presenting resulting coupons for the item on a screen of a mobile device. Each of these steps has been detailed above, but is also generally restated below.

The search parameters are chosen from the region of the search, items, stores, online sites, types of coupons, and types of discounts. Preferably, the entering step further includes the step communicating the region from a GPS in the mobile device. The entering step, searching step, and presenting step can be repeatably performed as a user changes location in order to update the user with the most current and local coupon information. Various sources can be searched for coupons as described above.

The presenting step can be further defined as presenting resulting coupons in a form such as a list form, a map form, and combinations thereof. The presenting step can further include the step of alerting a user of a notice such as store-specific offers and promos. This alert can be in the form of a sound or a visual alert on the display screen of the mobile device.

The method can further include the step of selecting a coupon from the resulting coupons generated by the coupon search engine. Once a coupon is selected, additional coupons for generic or competitor items can be displayed on the screen. The coupons selected can also be stored on computer-readable medium such as computer-readable medium of the mobile device or a cloud. The coupon can be saved to a list on computer-readable memory chosen such as a “To Use” list and a “Favorites” list. A barcode of the coupon can be displayed on the screen of the mobile device and the barcode can be scanned at a store in order to use the coupon. After this, it can be selected that the coupon has been used.

Additionally, before the entering step, the method can further include the step of generating a shopping list and the entering step further includes the step of entering search parameters for items on the shopping list. The generating step can be further defined as scanning barcodes of items and saving the barcodes in computer-readable memory on the mobile device. The entering step can further include the step of scanning a barcode of an item in a store. The method can also further include the steps of learning shopping patterns of the user and suggesting repurchases based on availability of items and coupons. The method can further include the step of calculating a total amount of savings obtained by using coupons. Other additional steps described above can also be used with this method.

The present invention also provides more generally for a method of generating coupons by scanning barcodes of items, creating a shopping list of items from the scanned barcodes, searching for coupons for the items based on the scanned barcodes with the coupon search engine, and presenting resulting coupons for the items on a screen of a mobile device. Each of these steps has been described above.

Any of the components of the mobile coupon application 10 can also interact with social media websites such as FACEBOOK® (Facebook, Inc.). For example, items in the shopping list function 14 can be listed on a user's profile page on FACEBOOK® (Facebook, Inc.). Coupons can be displayed on FACEBOOK® (Facebook, Inc.) that match the shopping list function 14 or favorite items in the coupon search engine 12. The intelligent learning function can prompt messages or posts on a user's page reminding them about products and coupons as described above. The coupon search engine 12 can also interact with merchants that the user “likes”, so that coupons from those merchants are displayed or suggested.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### EXAMPLE 1

A version of the mobile coupon application 10 can operate in the following manner. The GPS (once activated by the user as described above) knows which grocery store the user has entered. Alternatively, the user selects a store from a list of stores saved in a favorites list. The user selects a list, whether it is a list that the user has entered manually, or a list of items that the user has previously entered in the user's Favorite Menu selection, or if the user finds a recipe online and the ingredients are sent to the user's mobile device. As the user finds the items in the store, they are checked off of the inventory and archived for another time. Also, as the items are checked off, a coupon (if available) is electronically communicated to the mobile coupon application 10 on the user's mobile device and the user is alerted to its availability. If there is a store coupon or a manufacturer's coupon available for a particular item, it is delivered electronically to the mobile coupon application as an e-coupon or to a shopper's card as described above. The user can click to save the coupon to use on that shopping trip, or the user can click cancel if they do not want the coupon. The user goes to the cashier when ready to check out and presents their mobile device with the e-coupons for scanning and/or their shopper's card with the coupons on it.

The user walks down the aisles of the store and does their shopping. As the user picks up each item, the barcode can be scanned from the scanning function 16 or from a separate scanning application on the user's mobile device that is in communication with the mobile coupon application 10. If there is a store coupon or a manufacturer's coupon available for a particular item, it is delivered electronically to the mobile coupon application as an e-coupon or to a shopper's card as described above. The user can click to save the coupon to use on that shopping trip, or the user can click cancel if they do not want the coupon. The user goes to the cashier when ready to check out and presents their mobile device with the e-coupons for scanning and/or their shopper's card with the coupons on it.

### EXAMPLE 2

A different version of the mobile coupon application 10 can operate in the following manner. The user can inventory their pantry/fridge by using the scanning function 16 and enter item expiration dates or the item can come with set expiration dates as described above (e.g. 30 days advance, 1 day advance). Repeat perishable purchases (e.g. milk, eggs) can be set to have alerts as defined by the user for sales. For example, the alert can be set to only tell the user when milk is on sale for a certain amount off (e.g. at least $0.30 off) at any of the user's favorite quick-stop shopping locations (e.g. CVS, Speedway). A “follow-me” feature can be toggled on the mobile coupon application 10 so that when the user is out walking or driving, the GPS can communicate with any of the user's lists and alert them which stores within a certain user-defined distance has an item of interest on sale (as defined by the user).

### EXAMPLE 3

An additional extended feature can be used with the mobile coupon application 10. When a coupon is found for a user's exact item, competing manufacturers and merchants can push to have their item beat that price by alerting the user and delivering and displaying an immediate coupon electronically to the mobile coupon application that can be used for the competing manufacturer's item to beat the price. For example, the user can scan a tube of CREST® toothpaste and a coupon appears for $0.30 off. If COLGATE® pays to join, whenever a CREST® coupon is delivered, COLGATE® can deliver a competing coupon for its comparable item to the user for $0.40 off or such other enticement as defined by the merchant, so that the user can instantly change their purchase. To accept the coupon, the user can add the item and “replace” it over the CREST® item. The merchant can immediately be notified or provided feedback electronically that its efforts were successful (as shown in FIG. 4), thus assisting the merchant in myriad ways with marketing, demographics, or other merchant-defined criteria.

### EXAMPLE 4

Using the barcode scanning feature on your mobile device, when paper coupons arrive in the mail, or if printed off the Internet or from any other coupon database, the user can scan the barcode on the printed coupon and have those coupons automatically search through and automatically attach to items in the user's lists so that when the user is ready to make a purchase, the coupon is already attached to the item and is available for immediate use, or if the coupon then places the item in the user's predefined target price range, an alert will signal to the user that the item is within the user's target range and the user can make a purchase if desired. The user does not have to look through coupons and decide whether or not to keep those; rather, the user can simply flip through coupons and scan the barcodes and the present invention will search through the user's list and pair up any coupons that match the items in the user's lists and/or offer the user a comparable product to choose from.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A mobile coupon application, comprising:
a coupon search engine in electronic communication with a shopping list function and a scanning function, said mobile coupon application stored on a computer-readable medium on a mobile device.

2. A method of generating coupons, including the steps of:
entering search parameters on a coupon search engine;
searching for coupons for an item with the coupon search engine; and
presenting resulting coupons for the item on a screen of a mobile device.

3. The method of claim 2, wherein the search parameters are chosen from the group consisting of region of the search, items, stores, online sites, types of coupons, and types of discounts.

4. The method of claim 2, wherein the search parameter is a region of the search and wherein said entering step further includes the step communicating the region from a GPS in the mobile device.

5. The method of claim 4, wherein said entering step, searching step, and presenting step are repeatably performed as a user changes location.

6. The method of claim 2, wherein said searching step is further defined as searching a source chosen from the group consisting of local stores, in-store coupons or rebates, vendor/merchant sites, promo code websites, social media websites, coupon books, discount card memberships, deal of the day websites, coupon mailers, newspapers, magazines, local neighborhood circulars, and combinations thereof.

7. The method of claim 2, wherein said presenting step is further defined as presenting resulting coupons in a form chosen from the group consisting of a list form, a map form, and combinations thereof.

8. The method of claim 2, wherein said presenting step further includes the step of alerting a user of a notice chosen from the group consisting of store-specific offers and promos.

9. The method of claim 2, further including the step of selecting a coupon from the resulting coupons.

10. The method of claim 9, further including the step of displaying additional coupons for generic or competitor items on the screen.

11. The method of claim 9, further including the step of storing the coupon on computer-readable memory chosen from the group consisting of computer-readable memory of the mobile device and a cloud.

12. The method of claim 9, further including the step of saving the coupon to a list on computer-readable memory chosen from the group consisting of a to use list and a favorites list.

13. The method of claim 9, further including the step of displaying a barcode of the coupon on the screen of the mobile device and scanning the barcode at a store.

14. The method of claim 13, further including the step of selecting that the coupon has been used.

15. The method of claim 2, before said entering step, further including the step of generating a shopping list and wherein said entering step further includes the step of entering search parameters for items on the shopping list.

16. The method of claim 15, wherein said generating step is further defined as scanning barcodes of items and saving the barcodes in computer-readable memory on the mobile device.

17. The method of claim 2, wherein said entering step further includes the step of scanning a barcode of an item in a store.

18. The method of claim 2, further including the steps of learning shopping patterns of the user and suggesting repurchases based on availability of items and coupons.

19. The method of claim 2, further including the step of calculating a total amount of savings obtained by using coupons.

20. The method of claim 9, further including the step of sending the selected coupons electronically to a shopper's card.

21. The method of claim 9, further including the steps of a competing manufacturer pushing a coupon for a competing product to the mobile coupon application, and displaying the coupon to the user.

22. The method of claim 21, further including the steps of the user selecting the coupon for the competing product, and generating electronic feedback for the competing manufacturer.

23. The method of claim 2, further including the steps of scanning a coupon, searching user lists, and attaching the coupon to a matching item on the list if present.

24. A method of generating coupons, including the steps of:
scanning barcodes of items;
creating a shopping list of items from the scanned barcodes;
searching for coupons for the items based on the scanned barcodes with the coupon search engine; and
presenting resulting coupons for the items on a screen of a mobile device.
